(19) United States
(12) Patent Application Publication
(10) Pub. No.: US 2010/0210386 A1
(43) Pub. Date: Aug. 19, 2010

(54) TORQUE LIMITER ARRANGEMENT FOR A HORIZONTAL GRINDER

(76) Inventor: Thomas F. Long, JR., Wichita Falls, TX (US)

Correspondence Address: JOHN R. BENEFIEL, 525 Lewis Street, BIRMINGHAM, MI, 48009, US

(21) Appl. No.: 12/704,581

(22) Filed: Feb. 12, 2010

Related U.S. Application Data
(60) Provisional application No. 61/207,539, filed on Feb. 13, 2009.

(51) Int. Cl. F16H 7/00; F16D 43/204

(52) U.S. Cl. 474/148; 192/54.52

(57) ABSTRACT

A compact low capacity torque limiter is installed in a drive sheave of a belt drive connecting an engine to the hammer mill of a horizontal grinder.

### CROSS REFERENCE TO RELATED APPLICATIONS

This application claims the benefit of U.S. provisional application No. 61/207,539 filed Feb. 13, 2009.

### BACKGROUND OF THE INVENTION

This invention concerns torque limiter applications and particularly in horizontal grinders used in community wood. Such grinders feed refuse wood material with conveyor to enter a hammer mill which carries out the reduction of heavy wood scrap. Such equipment involves powerful diesel engines in the order of 1000 hp.

Such mills occasionally jam, potentially bringing all of the drive components to a stop. Such large engines cannot be allowed to stop in this event as considerable damage can be done to the engine components in such an event.

For this reason torque limiters have been employed to automatically release and disconnect the driving components from the mill in the event of a jam causing torque increases beyond a preset limit.

In U.S. Pat. No. 6,474,579 such a torque limiter installation is described. The connection between the prime mover and the mill is by a belt drive comprised of a driving sheave directly connected to the motor and a driven sheave driven by a belt circulating about both sheaves equipped with a belt tensioner mechanism. There is a large reduction ratio between the driving sheave and driven sheave, which is much larger in diameter than the driving sheave to provide the reduction ratio.

The conventional wisdom, as typified by the disclosure of U.S. Pat. No. 6,474,579, is to associate the torque limiter device with the driven sheave since by disconnecting at this point in the drive train, the momentum of the belt, driven sheave and idler wheel components is not absorbed by the hammer mill components when a jam occurs stopping the mill. This could possibly create increased damage to the mill components by the momentum of those components being absorbed by the now stopped mill. The installation of a torque limiter device in the driven sheave requires a large capacity costly device since the driven sheave transmits substantial torque by virtue of the reduction ratio between the sheaves in order to increase the torque applied to the hammer mill.

It is the object of the present invention to improve such a torque limiter arrangement so as to reduce the size and capacity of the required torque limiter device itself to thereby reduce the cost of the arrangement.

### SUMMARY OF THE INVENTION

The above object and others which will be understood by those skilled in the art upon a reading of the following specification and claims are achieved by providing a torque limiter device which is associated with the drive sheave rather than the driven sheave, allowing use of a lower torque capacity and smaller size device which thus may be lower in cost. The drive release will be carried out more quickly so that any addition to the momentum of the driven sheave, the belt, and idler wheel after the jam is minimized such that any increase in momentum of those components by their being continued to be driven by the engine for a brief period after a jam occurs is less than would otherwise be the case. Thus, the hammer mill components will not suffer increased damage due to their absorbing the increased momentum of the drive sheave, belt and idler while better insuring that engine damage because of a sudden engine stoppage induced by the jam conditions will be avoided.

### DESCRIPTION OF THE DRAWING FIGURES

FIG. 1 is a simplified side elevational view of a horizontal grinder with associated drive components.

FIG. 2 is an enlarged view of the horizontal grinder drive components incorporating a torque limiter arrangement according to the present invention.

FIG. 3 is an enlarged partially sectional view of a torque limiter device associated with a drive sheave shown in FIG. 2.

FIG. 4 is a reduced size partially sectional view of an alternate drive connection to a torque limiter device which may be used in the torque limiter arrangement of the present invention.

FIG. 5 is a pictorial view of a radial safety element type torque limiter which alternatively may be used in the torque limiter arrangement according to the invention.

FIG. 6 is an enlarged fragmentary pictorial view of the horizontal grinder drive system incorporating a torque limiter arrangement according to the invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

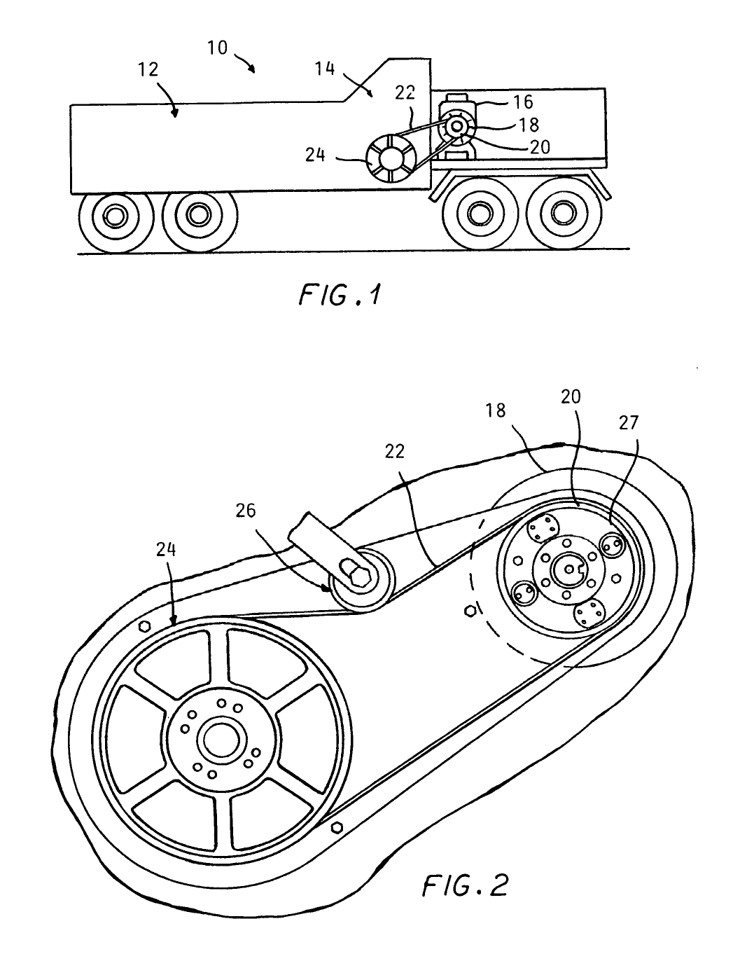

Referring to the drawings, FIG. 1 shows a simplified representation of a horizontal grinder 10 of the type described, in which wood material is fed onto a conveyor from a loading end 12 which drives the material to a hammer mill 14. Such equipment is well known in the art and accordingly will not be described in further detail.

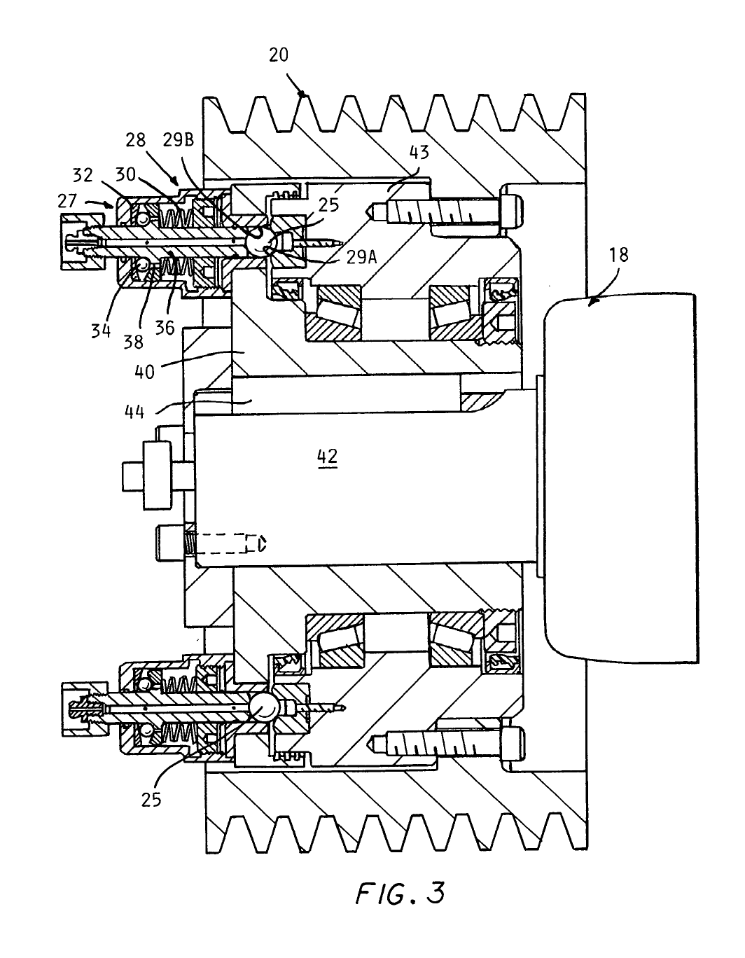

A diesel engine 16 drives friction clutch 18, having an output shaft 42 (FIG. 3) which is connected to a drive sheave 20 which is connected via a drive belt 22 to rotate a larger diameter driven sheave 24, achieving a reduction and increased torque level in the driven sheave 24.

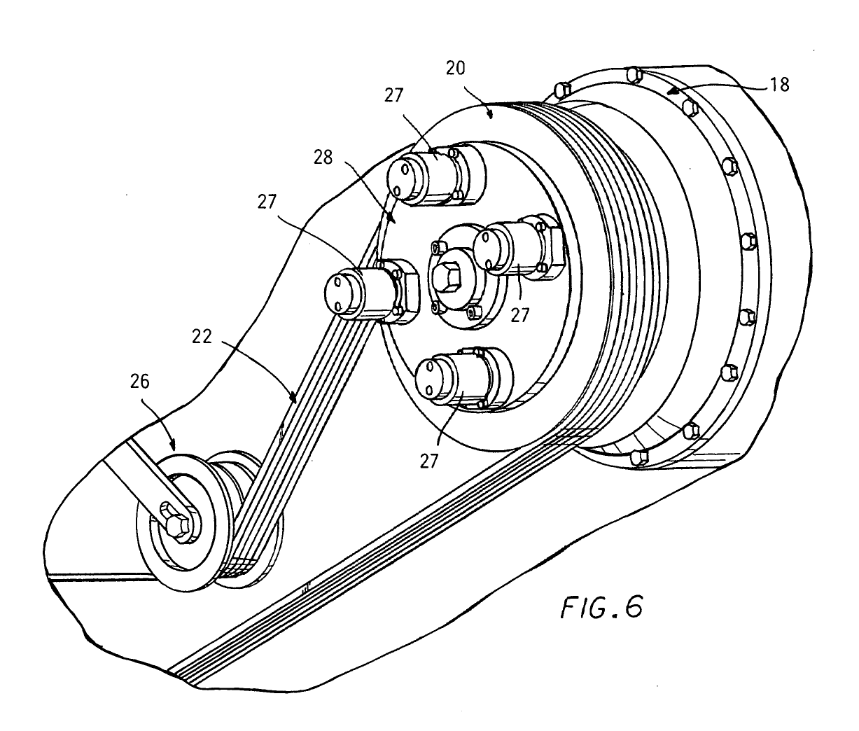

As seen in FIGS. 2 and 6, a belt tensioner mechanism of the type including a tensioner wheel 26 which engages the belt 22 as shown is typically included in such a belt drive system.

According to the concept of the present invention, a torque limiter device 28 is associated with the drive sheave 20 instead of the driven sheave 24 as is done according to conventional practice.

When associated with the drive sheave 24, the torque limiter device 28 may be of a smaller size and torque capacity than what is required when the torque limiter is associated with the driven sheave 24 and will be released more quickly to earlier discontinue any driving input from the engine 16 when a jam in the hammer will occur. While the momentum of the driven sheave 24, drive belt 22 and tensioner wheel 26 will be absorbed by the components of the hammer mill 14, the more rapid release of the torque limiter of the drive sheave will lessen the momentum imparted to these components by its earlier release and thus minimize the energy moving of the driven sheave, tensioner wheel, and belt which these components must absorb.

In addition, the smaller capacity of the torque converter reduces its cost and also its smaller size can better be accommodated in tight spaces.

The torque limiter device 28 is preferably of a type which is commercially available from the Brunel Corporation of Wichita Falls, Tex. and includes a plurality of safety elements 27, which can be varied in number to change the release torque level, two safety elements shown installed in the torque limiter device 28 in FIG. 2.

Referring to FIG. 3, the safety elements 27 each includes a large ball 28 which is held in engagement by a plunger 36 with aligned seats or pockets 29A,29B formed in a flange 40 connected to shaft 42 and in a member 43 fixed to the drive sheave 20. A series of Belleville springs 30 acts on tapered races 32, to holding small balls 34 a radially inward position in engagement with a shoulder 38 on the plunger 36 on a shoulder 38 to hold the plunger 36 in the axial position shown preventing axial movement of the large ball 28.

At a predetermined torque level generated by a driving connection between shaft 42 and flange 40 provided by the presence of the ball 28 and into member 43, the camming force of the balls 28 overcomes the spring force generated by springs 30 transmitted and moves the plunger 36 to the left axially, and the small balls 34 are forced radially out, spreading the tapered seats 32 apart. The small balls 34 then begin to ride on the outer diameter of shoulder 38 to eliminate any spring pressure acting to resist axial movement of the plunger 36. The drive sheave 20 is then disconnected from the flange member 40 which can than freely rotate driven by clutch output shaft 42 and key 44 so that the engine 16 continues to run.

The torque limiter device 28 must be thereafter be reset to reestablish the driving connection in the well known manner. This type of safety overload releases at a consistent preset torque level compared to shear pins, releases quicker than electrical overload devices, and does not have any tendency to overheat compared with slip clutches.

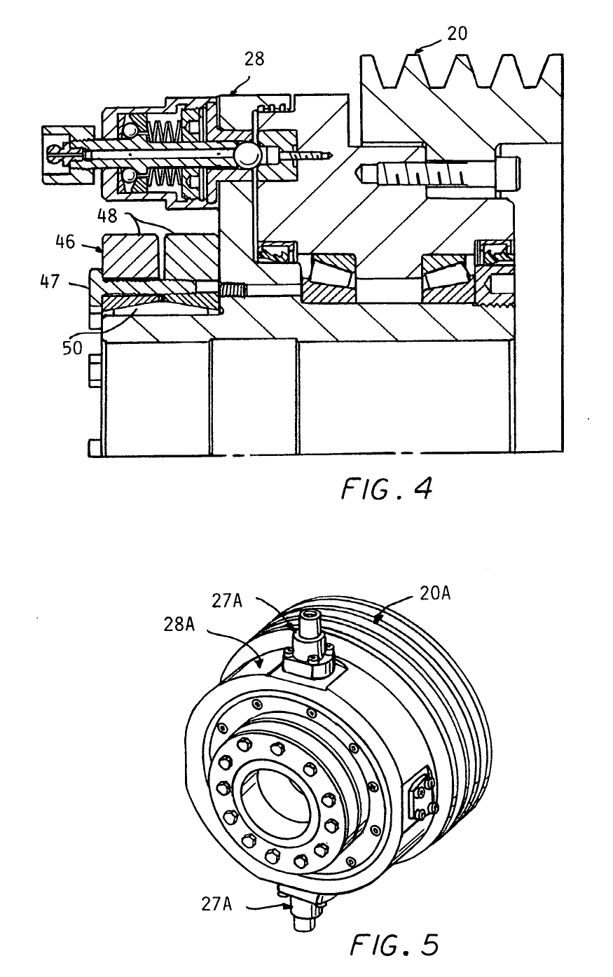

FIG. 4 shows a keyless connector 46 with collars 43 having tapered openings engaging a tapered ring 50 or being compressed together with screws 47 to create a driving connection.

FIG. 5 shows a torque limiter 28A mounted to a drive sheave 20A having two radially directed safety elements 27A. This orientation reduces the axial clearance needed where available axial clearance space is limited.

FIG. 6 also shows the torque limiter device 28 installed in the drive sheave 20, but with four safety elements 27 installed to create an increased torque release level.

Accordingly, a lower cost, smaller torque limiter can be used while reliably protecting the engine from the damage of a “hot stop”. The quicker disconnect action of the smaller torque limiter 28 minimizes mill damage from the decreased momentum of the belt, idler and driven sheave, and allows the cheaper, smaller torque limiter device to be used.

1. A torque limiter arrangement in a horizontal grinder having a hammer mill driven by an engine with a belt driving connection comprised of a driving sheave connected to an engine driven clutch output shaft and a driven sheave engaged by a belt driven by said drive sheave, the improvement comprising a torque limiter device interposed between said drive sheave and said clutch output shaft interrupting said driving connection therebetween to allow continued running of said engine upon development of a jam in said hammer mill.

2. The horizontal grinder according to claim 1 wherein said torque limiter includes a plurality of plungers held against respective balls seated in aligned pockets in respective members rotatable with clutch output shaft and said drive sheave to establish a driving relationship therebetween, said plungers able to be cammed out upon development of a predetermined torque transmitted through said balls to allow said balls to be moved out of one pocket and thereby discontinue said driving relationship of said engine with said drive sheave.

3. The horizontal grinder according to claim 1 wherein said torque limiter device is mounted at least partially within said drive sheave.

4. A method of protecting an engine driving a horizontal grinder hammer mill from a hot engine shut down upon development of a jam condition in said horizontal grinder wherein said engine drives a drive sheave which drives a driven sheave by an intermediate belt, comprising drivingly connecting said drive sheave to said engine by an associated torque limiter device disconnecting said drive connection upon development of a predetermined transmitted torque into said drive sheave.

5. The method according to claim 4 wherein said torque limiter is at least partially recessed within said drive sheave.
